(19) United States
(12) Patent Application Publication
(10) Pub. No.: US 2024/0219322 A1
(43) Pub. Date: Jul. 4, 2024

(54) IMAGING METHOD

(71) Applicant: SHENZHEN XPECTVISION TECHNOLOGY CO., LTD., Shenzhen (CN)

(72) Inventor: Peiyan CAO, Shenzhen (CN)

(73) Assignee: SHENZHEN XPECTVISION TECHNOLOGY CO., LTD., Shenzhen (CN)

(21) Appl. No.: 18/605,263

(22) Filed: Mar. 14, 2024

Related U.S. Application Data
(63) Continuation of application No. PCT/CN2021/118133, filed on Sep. 14, 2021.

(51) Int. Cl. G01N 23/046; G01N 23/083

(52) U.S. Cl. CPC G01N 23/046; G01N 23/083; G01N 2223/612

(57) ABSTRACT

Disclosed herein is an imaging method including attaching image agents to portions of an object; expanding the portions of the object in three dimensions (3D); generating a 3D image of the image agents based on interactions of the image agents with X-rays incident on the object after said attaching and said expanding are performed.

### CROSS-REFERENCE TO RELATED APPLICATION

This application is a continuation of International Patent Application NO. PCT/CN2021/118133, field on Sep. 14, 2021, entitled “X-RAY IMAGING IN EXPANSION MICROSCOPY”, the entire contents of which are incorporated herein by reference.

### BACKGROUND

A radiation detector is a device that measures a property of a radiation. Examples of the property may include a spatial distribution of the intensity, phase, and polarization of the radiation. The radiation may be one that has interacted with an object. For example, the radiation measured by the radiation detector may be a radiation that has penetrated the object. The radiation may be an electromagnetic radiation such as infrared light, visible light, ultraviolet light, X-ray, or γ-ray. The radiation may be of other types such as α-rays and β-rays. An imaging system may include one or more image sensors each of which may have one or more radiation detectors.

### SUMMARY

Disclosed herein is an imaging method, including: attaching image agents to portions of an object; expanding the portions of the object in three dimensions (3D); generating a 3D image of the image agents based on interactions of the image agents with X-rays incident on the object after said attaching and said expanding are performed.

### BRIEF DESCRIPTION OF THE DRAWINGS

FIG. 1 schematically shows a radiation detector, according to an embodiment.

FIG. 2 schematically shows a simplified cross-sectional view of the radiation detector, according to some embodiments.

FIG. 3 schematically shows a detailed cross-sectional view of the radiation detector, according to some embodiments.

FIG. 4 schematically shows a detailed cross-sectional view of the radiation detector, according to some alternative embodiments.

FIG. 5A-FIG. 5B schematically show perspective views of an object going through an expansion microscopy process, according to some embodiments.

FIG. 6A-FIG. 6B schematically show perspective views of an imaging apparatus operating on the result of the expansion microscopy process, according to some embodiments.

FIG. 7 is a flowchart generalizing the process described in FIG. 5A-FIG. 6B.

### DETAILED DESCRIPTION

### Radiation Detector

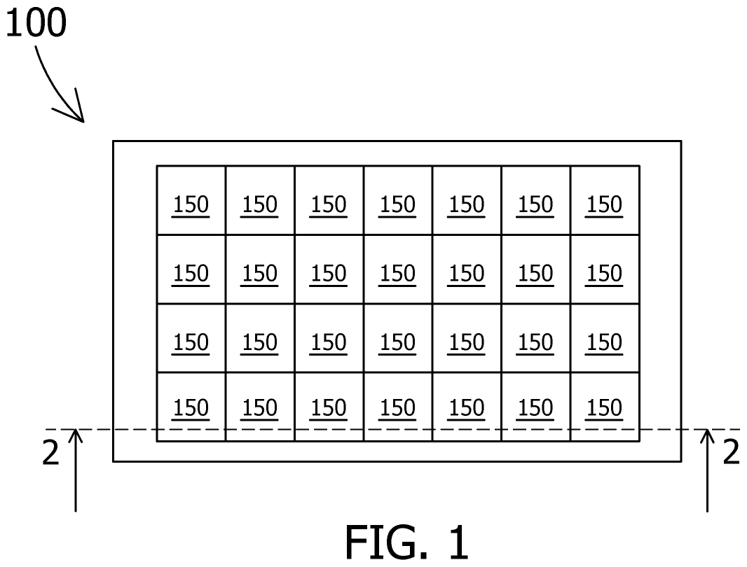

FIG. 1 schematically shows a radiation detector 100 in some embodiments. The radiation detector 100 may include an array of pixels 150 (also referred to as sensing elements 150). The array may be a rectangular array (as shown in FIG. 1), a honeycomb array, a hexagonal array, or any other suitable array. The array of pixels 150 in the example of FIG. 1 has 4 rows and 7 columns; however, in general, the array of pixels 150 may have any number of rows and any number of columns.

Each pixel 150 may be configured to detect radiation from a radiation source (not shown) incident thereon and may be configured to measure a characteristic (e.g., the energy of the particles, the wavelength, and the frequency) of the radiation. A radiation may include particles such as photons and subatomic particles. Each pixel 150 may be configured to count numbers of particles of radiation incident thereon whose energy falls in a plurality of bins of energy, within a period of time. All the pixels 150 may be configured to count the numbers of particles of radiation incident thereon within a plurality of bins of energy within the same period of time.

When the incident particles of radiation have similar energy, the pixels 150 may be simply configured to count numbers of particles of radiation incident thereon within a period of time, without measuring the energy of the individual particles of radiation.

Each pixel 150 may have its own analog-to-digital converter (ADC) configured to digitize an analog signal representing the energy of an incident particle of radiation into a digital signal, or to digitize an analog signal representing the total energy of a plurality of incident particles of radiation into a digital signal.

The digital signals obtained by all pixels 150 of the radiation detector 100 represent a 2D (2-dimensional) distribution of the characteristic of the incident radiation measured by the pixels 150 (e.g., the energy of the particles, the wavelength, and the frequency of the incident radiation). This 2D distribution may be considered a 2D image of the object (or scene) in the field of view of the radiation detector 100. As a result, a 2D image is not limited to something that can be seen by naked eyes.

In computed tomography, a 3D (3-dimensional) distribution of the measured characteristic may be generated from multiple 2D distributions of the measured characteristic.

This 3D distribution may be considered a 3D image of the object (or scene) in the field of view of the radiation detector 100. As a result, a 3D image is not limited to something that can be seen by naked eyes.

The pixels 150 may be configured to operate in parallel. For example, when one pixel 150 measures an incident particle of radiation, another pixel 150 may be waiting for a particle of radiation to arrive. The pixels 150 may not have to be individually addressable.

The radiation detector 100 described here may have applications such as in an X-ray telescope, X-ray mammography, industrial X-ray feature detection, X-ray microscopy or microradiography, X-ray casting inspection, X-ray non-destructive testing, X-ray weld inspection, X-ray digital subtraction angiography, etc. It may be suitable to use this radiation detector 100 in place of a photographic plate, a photographic film, a PSP plate, an X-ray image intensifier, a scintillator, or another semiconductor X-ray detector.

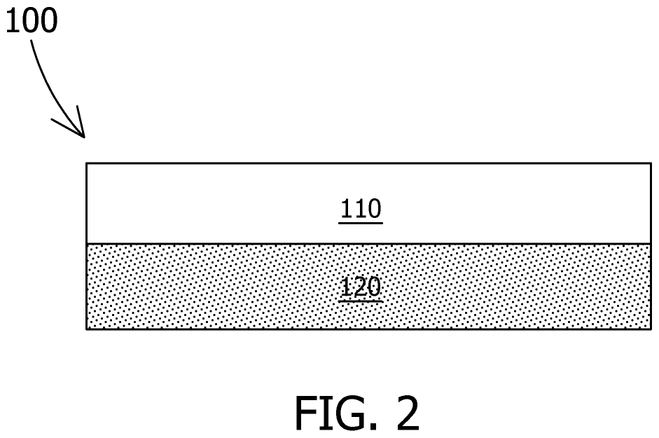

FIG. 2 schematically shows a simplified cross-sectional view of the radiation detector 100 of FIG. 1 along a line 2-2, according to an embodiment. Specifically, the radiation detector 100 may include a radiation absorption layer 110 and an electronics layer 120 (which may include one or more ASICs or application-specific integrated circuits) for processing or analyzing electrical signals which incident radiation generates in the radiation absorption layer 110. The radiation detector 100 may or may not include a scintillator (not shown). The radiation absorption layer 110 may include a semiconductor material such as silicon, germanium, GaAs, CdTe, CdZnTe, or a combination thereof. The semiconductor material may have a high mass attenuation coefficient for the radiation of interest.

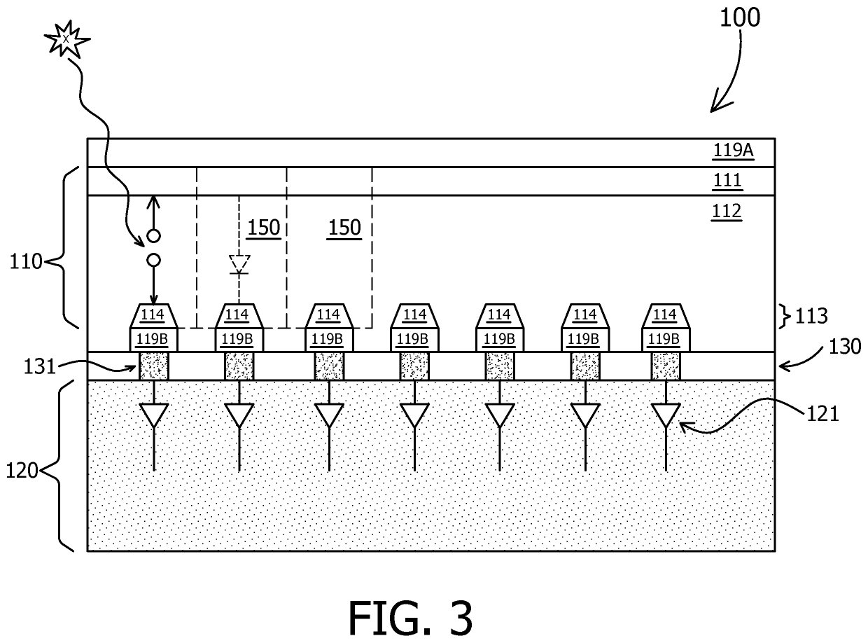

FIG. 3 schematically shows a detailed cross-sectional view of the radiation detector 100 of FIG. 1 along the line 2-2, as an example. Specifically, the radiation absorption layer 110 may include one or more diodes (e.g., p-i-n or p-n) formed by a first doped region 111, one or more discrete regions 114 of a second doped region 113. The second doped region 113 may be separated from the first doped region 111 by an optional intrinsic region 112. The discrete regions 114 may be separated from one another by the first doped region 111 or the intrinsic region 112. The first doped region 111 and the second doped region 113 may have opposite types of doping (e.g., region 111 is p-type and region 113 is n-type, or region 111 is n-type and region 113 is p-type). In the example of FIG. 3, each of the discrete regions 114 of the second doped region 113 forms a diode with the first doped region 111 and the optional intrinsic region 112. Namely, in the example in FIG. 3, the radiation absorption layer 110 has a plurality of diodes (more specifically, 7 diodes corresponding to 7 pixels 150 of one row in the array of FIG. 1, of which only 2 pixels 150 are labeled in FIG. 3 for simplicity). The plurality of diodes may have an electrical contact 119A as a shared (common) electrode. The first doped region 111 may also have discrete portions.

The electronics layer 120 may include an electronic system 121 suitable for processing or interpreting signals generated by the radiation incident on the radiation absorption layer 110. The electronic system 121 may include an analog circuitry such as a filter network, amplifiers, integrators, and comparators, or a digital circuitry such as a microprocessor, and memory. The electronic system 121 may include one or more ADCs (analog to digital converters). The electronic system 121 may include components shared by the pixels 150 or components dedicated to a single pixel 150. For example, the electronic system 121 may include an amplifier dedicated to each pixel 150 and a microprocessor shared among all the pixels 150. The electronic system 121 may be electrically connected to the pixels 150 by vias 131. Space among the vias may be filled with a filler material 130, which may increase the mechanical stability of the connection of the electronics layer 120 to the radiation absorption layer 110. Other bonding techniques are possible to connect the electronic system 121 to the pixels 150 without using the vias 131.

When radiation from the radiation source (not shown) hits the radiation absorption layer 110 including diodes, particles of the radiation may be absorbed and generate one or more charge carriers (e.g., electrons, holes) by a number of mechanisms. The charge carriers may drift to the electrodes of one of the diodes under an electric field. The electric field may be an external electric field. The electrical contact 119B may include discrete portions each of which is in electrical contact with the discrete regions 114. The term “electrical contact” maybe used interchangeably with the word “electrode”. In an embodiment, the charge carriers may drift in directions such that the charge carriers generated by a single particle of the radiation are not substantially shared by two different discrete regions 114 (“not substantially shared” here means less than 2%, less than 0.5%, less than 0.1%, or less than 0.01% of these charge carriers flow to a different one of the discrete regions 114 than the rest of the charge carriers). Charge carriers generated by a particle of the radiation incident around the footprint of one of these discrete regions 114 are not substantially shared with another of these discrete regions 114. A pixel 150 associated with a discrete region 114 may be an area around the discrete region 114 in which substantially all (more than 98%, more than 99.5%, more than 99.9%, or more than 99.99% of) charge carriers generated by a particle of the radiation incident therein flow to the discrete region 114. Namely, less than 2%, less than 1%, less than 0.1%, or less than 0.01% of these charge carriers flow beyond the pixel 150.

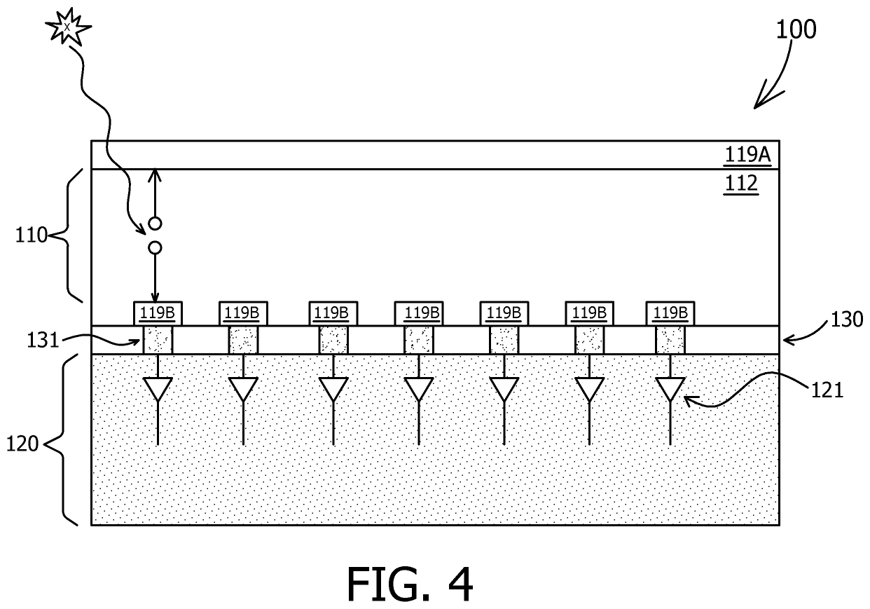

FIG. 4 schematically shows a detailed cross-sectional view of the radiation detector 100 of FIG. 1 along the line 2-2, according to an alternative embodiment. More specifically, the radiation absorption layer 110 may include a resistor of a semiconductor material such as silicon, germanium, GaAs, CdTe, CdZnTe, or a combination thereof, but does not include a diode. The semiconductor material may have a high mass attenuation coefficient for the radiation of interest. In some embodiments, the electronics layer 120 of FIG. 4 is similar to the electronics layer 120 of FIG. 3 in terms of structure and function.

When the radiation hits the radiation absorption layer 110 including the resistor but not diodes, it may be absorbed and generate one or more charge carriers by a number of mechanisms. A particle of the radiation may generate 10 to 100,000 charge carriers. The charge carriers may drift to the electrical contacts 119A and 119B under an electric field. The electric field may be an external electric field. The electrical contact 119B may include discrete portions. In some embodiments, the charge carriers may drift in directions such that the charge carriers generated by a single particle of the radiation are not substantially shared by two different discrete portions of the electrical contact 119B (“not substantially shared” here means less than 2%, less than 0.5%, less than 0.1%, or less than 0.01% of these charge carriers flow to a different one of the discrete portions than the rest of the charge carriers). Charge carriers generated by a particle of the radiation incident around the footprint of one of these discrete portions of the electrical contact 119B are not substantially shared with another of these discrete portions of the electrical contact 119B. A pixel 150 associated with a discrete portion of the electrical contact 119B may be an area around the discrete portion in which substantially all (more than 98%, more than 99.5%, more than 99.9% or more than 99.99% of) charge carriers generated by a particle of the radiation incident therein flow to the discrete portion of the electrical contact 119B. Namely, less than 2%, less than 0.5%, less than 0.1%, or less than 0.01% of these charge carriers flow beyond the pixel associated with the one discrete portion of the electrical contact 119B.

### Expansion Microscopy Process

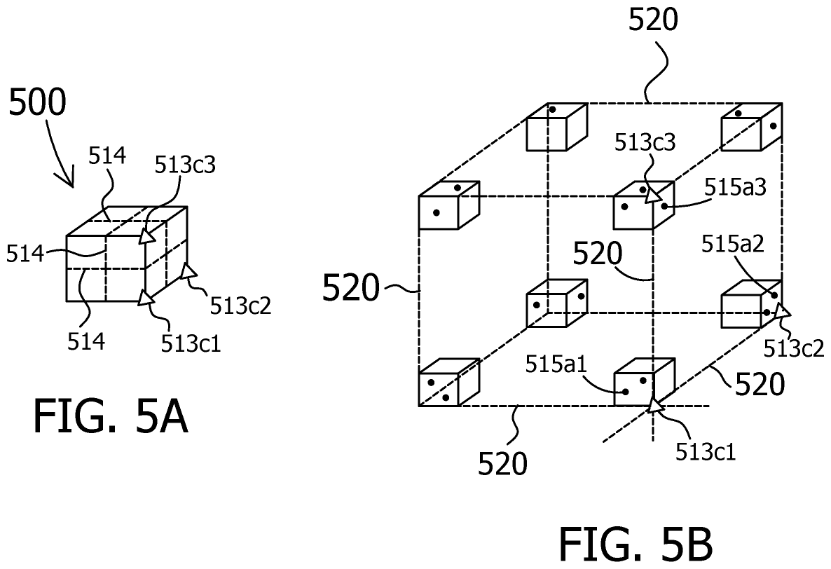

FIG. 5A-FIG. 5B schematically show perspective views of an object 500 going through an expansion microscopy process. For illustration, assume the object 500 has the shape of a cube as shown.

In some embodiments, the object 500 may be a biological specimen such as cells, internal organs, veins, etc. As a result, the object 500 includes biomolecules.

### Anchoring Chemical Linkers on Object

In one or more embodiments, with reference to FIG. 5A, the expansion microscopy process may start with anchoring chemical linkers (triangles in FIG. 5A) on the object 500. For illustration, assume that 8 chemical linkers are anchored on the object 500 and that the 8 chemical linkers are anchored at the 8 vertices (corners) of the object 500. For simplicity, only 3 of the 8 chemical linkers (i.e., chemical linkers 513c1, 513c2, and 513c3) are shown and labeled.

In case the object 500 is a biological specimen, the chemical linkers may include a compound that binds to the biomolecules of the object 500.

### Polymer Network

Next, in an embodiment, a polymer network (not shown in FIG. 5A for simplicity) may be formed around the object 500 such that the polymer network binds to the 8 chemical linkers. In other words, the object 500 are hooked onto the polymer network via the 8 chemical linkers.

Specifically, in some embodiments, the polymer network may be formed by first soaking the object 500 of FIG. 5A in a solution of monomers (e.g., sodium acrylate). As a result, the monomers self-assemble into polymer chains. When a growing polymer chain encounters a chemical linker, a covalent bond forms between the chemical linker and the polymer chain. In some embodiments, the polymer chains are cross-linked using a cross linker resulting in the polymer network. In some embodiments, the polymer chains and the cross links are formed simultaneously resulting in the polymer network by infusing the object 500 with both sodium acrylate and the cross linker at the same time.

In an embodiment, expanding the portions of the object involves introducing a swellable material into the object and causing the swellable material to swell. The image agents may be part of the swellable material.

### Weakening the Bonds in the Object

Next, in some embodiments, the bonds that hold the object 500 together may be weakened. In case the object 500 is a biological specimen, then detergents, enzymes, and or heat may be used to weaken the biomolecules of the object 500.

### Expansion

Next, in some embodiments, the polymer network may be expanded thereby pulling the 8 chemical linkers apart isotropically in 3D (i.e., in all three dimensions evenly). For simplicity, as a result of the 8 chemical linkers being pulled apart by the expanding polymer network, assume that the object 500 is torn apart along the dashed lines 514 (FIG. 5A) resulting in 8 separate portions as shown in FIG. 5B. In effect, these 8 portions of the object 500 are isotropically spaced farther apart from one another in 3D (i.e., in all 3 dimensions). In other words, the 8 portions of the object 500 are expanded isotropically in 3D (i.e., expanded in all 3 dimensions evenly).

In some embodiments, the polymer network may be expanded by adding water to the polymer network resulting the expanded polymer network 520 of FIG. 5B.

### Attaching Image Agents to the Portions

In some embodiments, with reference to FIG. 5B, image agents (solid circles) may be attached to the 8 portions of the object 500. For simplicity, only 3 of the image agents are shown and labeled (i.e., the image agents 515a1, 515a2, and 515a3), other image agents are shown but not labeled, and yet other image agents are not shown or labeled. The image agents may be alternatively attached to the portions before any chemical linkers are anchored to the object or before expanding the portions of the object.

### X-Ray Imaging of the Image Agents

### First 2D Image Capture

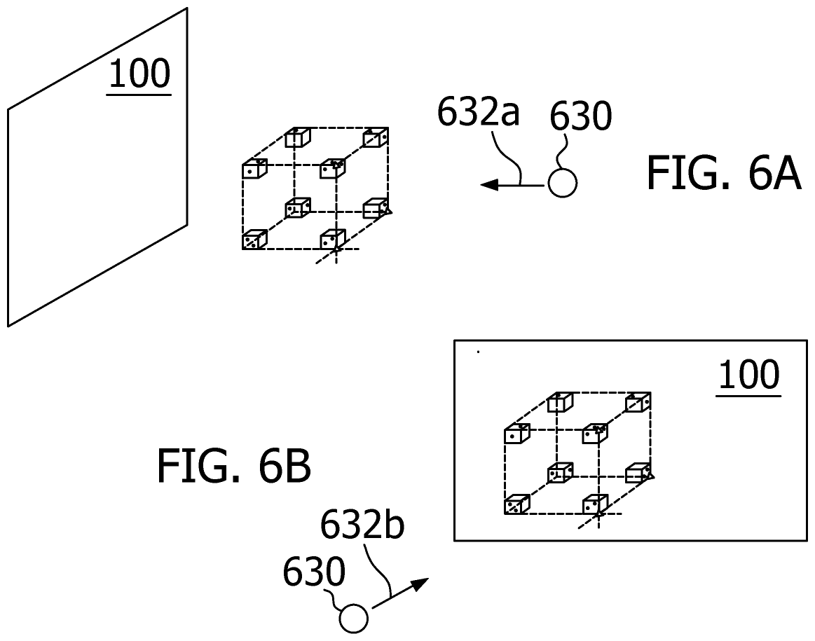

Next, in one or more embodiments, with reference to FIG. 6A, the 8 portions and the attached image agents along with the expanded polymer network 520 of FIG. 5B may be positioned in an imaging apparatus 100+630 for imaging. In some embodiments, the imaging apparatus 100+630 may include the radiation detector 100 and a radiation source 630.

In some embodiments, a first 2D image capture may be performed as follows. In one or more embodiments, the radiation source 630 may generate a radiation beam 632a toward the image agents and the radiation detector 100.

In some embodiments, each of the image agents may include an element that attenuates X-rays. As a result, the image agents are imageable with X-rays used for imaging. In some embodiments, the radiation beam 632a may be an X-ray beam. Therefore, using the radiation of the radiation beam 632a that has interacted with the image agents, the radiation detector 100 may capture a first 2D image of the image agents.

### Second 2D Image Capture

In some embodiments, after the radiation detector 100 captures the first 2D image of the image agents, the radiation detector 100 and radiation source 630 may be rotated around the image agents resulting in another arrangement of the imaging apparatus 100+630 as shown in FIG. 6B.

In some embodiments, with reference to FIG. 6B, a second 2D image capture may be performed as follows. In some embodiments, while the imaging apparatus 100+630 is arranged as shown in FIG. 6B, the radiation source 630 may generate a radiation beam 632b toward the image agents and the radiation detector 100. In some embodiments, the radiation beam 632b may be an X-ray beam. As a result, with the image agents being imageable with X-rays used for imaging, using the radiation of the radiation beam 632b that has interacted with the image agents, the radiation detector 100 may capture a second 2D image of the image agents.

3D Image of the Image Agents

Next, in some embodiments, after the radiation detector 100 captures the second 2D image, a 3D image of the image agents may be generated from the first and second 2D images. In some embodiments, the 3D image of the image agents may be generated from the first and second 2D images using computed tomography. In an embodiment, the generation of the 3D image from the first and second 2D images may be performed by the radiation detector 100.

Because the first and second 2D images are captured using X-rays for imaging (i.e., incident radiations captured by the radiation detector 100 are X-rays), the generation of the 3D image from the first and second 2D images is considered using X-rays for imaging.

Note that because the potions of the object 500 are expanded isotropically in 3D (i.e., in all 3 dimensions), the 3D image of the image agents is also the 3D image of the object 500 before the object 500 is torn apart.

### Flowchart for Generalization

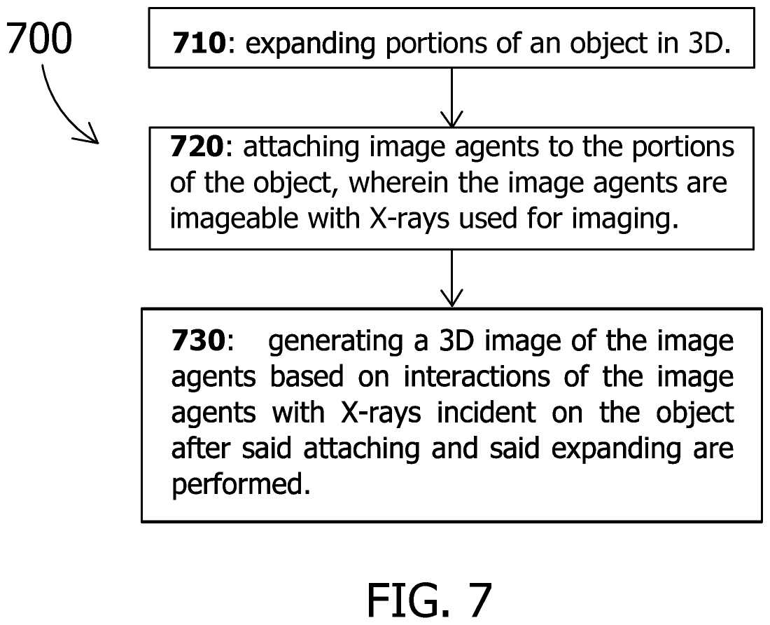

FIG. 7 shows a flowchart 700 generalizing the X-ray imaging process and the expansion microscopy process described above in FIG. 5A-FIG. 6B. Specifically, in step 710, portions of an object are expanded in 3D. For example, in some embodiments described above, the 8 portions of the object 500 are expanded in 3D when the expanding polymer network pulls the portions apart in 3D with the chemical linkers (e.g., the chemical linker 513c1, 513c2, and 513c3).

In step 720, image agents are attached to the portions of the object. For example, in the embodiments described above, the image agents (e.g., the image agents 515a1, 515a2, and 515a3 of FIG. 5B) are attached to the 8 portions of the object 500.

In addition, in step 720, the image agents are imageable with X-rays used for imaging. For example, in some embodiments described above, the image agents include a metal that absorbs X-rays; therefore, the image agents are imageable with X-rays used for imaging.

In step 730, a 3D image of the image agents is generated using X-rays for imaging, based on interactions of the image agents with X-rays incident on the object, after said attaching and said expanding are performed. For example, in the embodiments described above, the 3D image of the image agents (e.g., the image agents 515a1, 513a2, and 513a3) is generated from the first and second 2D images which are captured by the radiation detector 100 using X-rays from the radiation source 630 for imaging.

### ADDITIONAL EMBODIMENTS

### Heavy Metal in the Image Agents

In some embodiments, the element in the image agents may have atomic number of 23 or higher (e.g., a heavy metal). For example, copper, gold, silver, and platinum are heavy metals that may be used in the image agents.

### Micro Computed Tomography

In some embodiments, the radiation detector 100 has a spatial resolution of 1 micron or a higher spatial resolution (e.g., a spatial resolution of 0.6 micron).

### ALTERNATIVE EMBODIMENTS

### Characteristic X-Rays from the Image Agents for Imaging

In some embodiments described above, X-rays from the radiation beams 632a and 632b are used for capturing the first and second 2D images of the image agents respectively. Alternatively, characteristic X-rays from the image agents may be used for capturing the first and second 2D images of the image agents.

Specifically, in some embodiments, the image agents may generate characteristic X-rays when the image agents are bombarded with high-energy particles (e.g., protons, neutrons, or ions) or radiation with wavelengths shorter than wavelengths of X-rays (e.g., Gamma rays).

In addition, in some embodiments, the radiation beams 532a and 532b may be strong enough to cause the image agents to generate characteristic X-rays. In addition, in some embodiments, the radiation detector 100 may be configured to ignore incident radiation of the radiation beams 532a and 532b. In other words, the radiation detector 100 captures the first and second 2D images of the image agents using the incident characteristic X-rays from the image agents and ignoring the incident radiation from the radiation beams 632a and 632b.

In some embodiments, the radiation beams 632a and 632b from the radiation source 630 have different wavelengths than the characteristic X-rays from the image agents so that the radiation detector 100 is able to selectively receive and process the incident characteristic X-rays from the image agents and ignore the incident radiation of the radiation beams 632a and 632b from the radiation source 630.

### Attaching Before Expanding

In some embodiments described above, with reference to FIG. 5A-FIG. 6B, the 8 portions are isotropically expanded before the image agents are attached to the portions. Alternatively, with all other things being the same, the image agents may be attached to the portions before the portions are isotropically expanded. For example, the image agents may be attached to the portions while the monomers are being introduced to the object 500.

### Image Agents as Chemical Linkers

In some embodiments described above, the chemical linkers (e.g., the chemical linkers 513c1, 513c2, and 513c3) link the portions to the polymer network. Alternatively, with all other things being the same, the image agents may link the portions to the polymer network.

Specifically, in some embodiments, the expansion microscopy process may be as follows. Firstly, the image agents may be attached to the object 500 of FIG. 5A. Next, in some embodiments, the polymer network may be created that binds to the image agents. Alternatively, the image agents may be attached to the object 500 while the polymer network is being created.

Next, in some embodiments, the bonds that hold the object 500 together may be weakened or even broken.

Next, in some embodiments, the polymer network may be expanded in 3D thereby isotropically expanding the image agents in 3D. Next, in some embodiments, a 3D image of the image agents using X-rays for imaging may be generated after said expanding occurs.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An imaging method, comprising:
attaching image agents to portions of an object;
expanding the portions of the object in three dimensions; and
generating a 3D image of the image agents based on interactions of the image agents with X-rays incident on the object after said attaching and said expanding are performed.

2. The method of claim 1, wherein said expanding is isotropic.

3. The method of claim 1, wherein said expanding is performed before said attaching is performed.

4. The method of claim 1, wherein the said expanding is performed after said attaching is performed.

5. The method of claim 1, wherein the image agents comprise an element with an atomic number of 23 or higher.

6. The method of claim 1, wherein said expanding the portions of the object comprises:
anchoring chemical linkers on the object;
forming a polymer network that binds to the chemical linkers; and
expanding the portions by expanding the polymer network.

7. The method of claim 6, wherein the chemical linkers comprise compounds that bind to biomolecules of the object.

8. The method of claim 6, wherein the image agents is as the chemical linkers.

9. The method of claim 6, wherein the expanding the polymer network comprises:
adding water to the polymer network.

10. The method of claim 1, wherein said expanding the portions of the object comprises:
introducing a swellable material into the object;
expanding the portions by causing the swellable material to swell.

11. The method of claim 10, wherein the image agents is a part of the swellable material.

12. The method of claim 1, wherein, before the step of the expanding the portions of the object, further comprises: weakening bonds in the object.

13. The method of claim 12, wherein the weakening bonds in the object comprises:
using detergents, enzymes, and/or heat to weakening biomolecules of the object.

14. The method of claim 1, wherein said generating the 3D image of the image agents comprises:
capturing multiple 2D images of the image agents based on the interactions; and
generating the 3D image of the image agents from the multiple 2D images using computed tomography.

15. The method of claim 14, wherein the interactions are emission of characteristic X-rays of the image agents caused by the X-ray incident on the object.

16. The method of claim 14, wherein the interactions are attenuation of the X-ray incident on the object by the image agents.

17. The method of claim 14, wherein said capturing the multiple 2D images comprises:
rotating a radiation source and a radiation detector around the object such that the image agents are disposed between the radiation source and the radiation detector.
